(19) United States
(12) Patent Application Publication
(10) Pub. No.: US 2024/0356431 A1
(43) Pub. Date: Oct. 24, 2024

(54) POWER SUPPLY CONTROL DEVICE, POWER SUPPLY CONTROL METHOD AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Shinnosuke NAKAGUCHI, Yokkaichi-shi, Mie (JP); Masayuki KATO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/685,553

(22) PCT Filed: Jun. 29, 2022
(86) PCT No.: PCT/JP2022/025870

§ 371 Date: Feb. 22, 2024

(30) Foreign Application Priority Data
Aug. 25, 2021 (JP) 2021-137276

(51) Int. Cl. H02M 1/088; H02M 3/155

(52) U.S. Cl. CPC H02M 1/088; H02M 3/155

(57) ABSTRACT

In a power supply control device, a microcomputer causes the state of each of a plurality of second switches into which current is input from a first switch to transition to an off state or a current conduction state in which current can flow therethrough. The microcomputer adjusts the average value of the current flowing per unit time for at least one second switch, according to the one or more second switches that are in the current conduction state.

### CROSS-REFERENCE TO RELATED APPLICATIONS

This application is the U.S. national stage of PCT/JP2022/025870 filed on Jun. 29, 2022, which claims priority of Japanese Patent Application No. JP 2021-137276 filed on Aug. 25, 2021, the contents of which are incorporated herein.

### TECHNICAL FIELD

The present disclosure relates to a power supply control device, a power supply control method, and a computer program.

### BACKGROUND

JP 2020-167882A discloses a power supply control device for a vehicle that controls power supply from a DC power source to a plurality of loads. In this power supply control device, current is input from the DC power source to one end of a first switch. The current output from the other end of the first switch is divided into a plurality of currents. The plurality of currents are respectively input to ends on one side of the plurality of second switches. The plurality of currents output from the ends on the other side of the plurality of second switches flows through the plurality of loads.

When the state of the first switch is the on state, the control unit switches the state of each of the plurality of second switches to the on state or the off state. Thereby, power supply to each of the plurality of loads is controlled. The control unit can stop power supply to all loads by switching the state of the first switch to the off state.

In the power supply control device described in JP 2020-167882A, if the states of the first switch and all of the second switches are fixed in the on state, the average value of the current flowing per unit time through the first switch is the largest. This value needs to be permitted in the first switch. Accordingly, as the first switch, a large switch with a large permissible average value of current flowing per unit time is used. In a vehicle, space for disposing a power supply control device is limited. For this reason, it is preferable that the first switch of the power supply control device is a small switch.

The present disclosure has been made in view of such circumstances, and its purpose is to provide a power supply control device, a power supply control method, and a computer program according to which a small switch can be used as the first switch.

### SUMMARY

A power supply control device according to one aspect of the present disclosure includes: a first switch; and a processing unit configured to execute processing, in which the processing unit causes a state of each of a plurality of second switches to which current is input from the first switch to transition from an off state to a current conduction state in which current can flow therethrough, and the processing unit adjusts an average value of current flowing per unit time for at least one of the second switches, according to one or more second switches that are in the current conduction state.

In a power supply control method according to one aspect of the present disclosure, a computer executes: a step of causing a state of each of a plurality of second switches to which current is input from a first switch to transition from an off state to a current conduction state in which current flows therethrough; and a step of adjusting an average value of current flowing per unit time for at least one of the second switches, according to one or more second switches that are in the current conduction state.

A computer program according to one aspect of the present disclosure causes a computer to execute: a step of causing a state of each of a plurality of second switches to which current is input from a first switch to transition from an off state to a current conduction state in which current flows therethrough; and a step of adjusting an average value of current flowing per unit time for at least one of the second switches, according to one or more second switches that are in the current conduction state.

Note that the present disclosure can be realized not only as a power supply control device including such a characteristic processing unit, but also as a power supply control method having such characteristic processing as steps, or as a computer program for causing a computer to execute such steps. Also, the present disclosure can be implemented as a semiconductor integrated circuit that implements some or all of a power supply control device, or as a power source system that includes a power supply control device.

### Effects of the Present Disclosure

According to the above aspect, a small switch can be used as the first switch.

### BRIEF DESCRIPTION OF DRAWINGS

FIG. 1 is a block diagram showing a configuration of a main part of a power source system in a first embodiment.

FIG. 2 is an explanatory diagram of switching of a second switch.

FIG. 3 is a circuit diagram of a switch device.

FIG. 4 is an explanatory diagram of a relationship between a value of the voltage between both ends of the second switch and the state of the second switch.

FIG. 5 is a chart for describing a method for detecting a failure of the second switch.

FIG. 6 is a block diagram showing a configuration of a main part of a microcomputer.

FIG. 7 is a chart showing content of a state table.

FIG. 8 is a chart showing content of a duty ratio table.

FIG. 9 is a flowchart showing a procedure of power supply control processing for a load.

FIG. 10 is a flowchart showing a procedure of power supply control processing for a load.

FIG. 11 is a flowchart showing a procedure of switching processing for the first switch.

FIG. 12 is a circuit diagram of a switch device in a second embodiment.

FIG. 13 is an explanatory diagram of a relationship between the second switch current value and the state of the second switch.

FIG. 14 is a chart for describing a method for detecting a failure of the second switch.

FIG. 15 is a flowchart showing a procedure of power supply control processing for a load.

### DETAILED DESCRIPTION OF PREFERRED EMBODIMENTS

First, embodiments of the present disclosure will be listed and described. At least some of the embodiments described below may be combined as appropriate.

A power supply control device according to one aspect of the present disclosure includes: a first switch; and a processing unit configured to execute processing, in which the processing unit causes a state of each of a plurality of second switches to which current is input from the first switch to transition from an off state to a current conduction state in which current can flow therethrough, and the processing unit adjusts an average value of current flowing per unit time for at least one of the second switches, according to one or more second switches that are in the current conduction state.

In the power supply control device according to one aspect of the present disclosure, an average value of current flowing per unit time through the first switch is less than a value of current flowing through the first switch when the first switch and all of the second switches are fixed in an on state.

In the power supply control device according to one aspect of the present disclosure, when the state of the second switch is fixed in an on state or PWM control of the second switch is performed, the state of the second switch is caused to transition to the current conduction state.

The power supply control device according to one aspect of the present disclosure further includes a switching circuit configured to switch the state of the first switch to an on state or an off state, in which the switching circuit switches the state of the first switch to the off state if the value of the current flowing through the first switch reaches a value greater than or equal to a current threshold value.

In the power supply control device according to one aspect of the present disclosure, the processing unit instructs switching of the second switch to the off state, and if a period during which a value of a voltage between both ends of the second switch is maintained at a value within a predetermined range reaches a value greater than or equal to a predetermined period when switching of the second switch to the off state has been instructed, the processing unit instructs switching of the first switch to the off state.

In the power supply control device according to one aspect of the present disclosure, the processing unit instructs switching of the second switch to the off state, and if a period during which a value of current flowing through the second switch is maintained at a value within a second predetermined range reaches a value greater than or equal to a second predetermined period when switching of the second switch to the off state has been instructed, the processing unit instructs switching of the first switch to the off state.

In the power supply control device according to one aspect of the present disclosure, the processing unit instructs switching of the second switch to the off state, and if a value of a voltage between both ends of the second switch is less than a predetermined voltage value when switching of the second switch to the off state has been instructed, the processing unit instructs switching of the first switch to the off state.

In the power supply control device according to one aspect of the present disclosure, when switching of the second switch to the off state has been instructed, if a value of a voltage between both ends of a specific switch determined in advance among the plurality of second switches is less than the predetermined voltage value, the processing unit instructs switching of the first switch to the off state.

In the power supply control device according to one aspect of the present disclosure, when switching of the second switch to the off state has been instructed, if the value of the voltage between both ends of a second switch that is not the specific switch is less than the predetermined voltage value, the processing unit lowers the average value of the current flowing per unit time through a second switch that is not the second switch in which the value of the voltage between both ends is less than the predetermined voltage value.

In the power supply control device according to one aspect of the present disclosure, the processing unit instructs switching of the second switch to the off state, and if the value of the current flowing through the second switch exceeds a predetermined current value when switching of the second switch to the off state has been instructed, the processing unit instructs switching of the first switch to the off state.

In the power supply control device according to one aspect of the present disclosure, when switching of the second switch to the off state has been instructed, if a value of current flowing through a specific switch determined in advance among the plurality of second switches exceeds the predetermined current value, the processing unit instructs switching of the first switch to the off state.

In the power supply control device according to one aspect of the present disclosure, when switching of the second switch to the off state has been instructed, if the value of the current flowing through a second switch that is not the specific switch exceeds the predetermined voltage value, the processing unit lowers the average value of the current flowing per unit time through a second switch that is not the second switch in which the current with the value exceeding the predetermined current value flows.

In a power supply control method according to one aspect of the present disclosure, a computer executes: a step of causing a state of each of second switches to which current is input from a first switch to transition from an off state to a current conduction state in which current flows therethrough; and a step of adjusting an average value of current flowing per unit time for at least one of the second switches, according to one or more second switches that are in the current conduction state.

A computer program according to one aspect of the present disclosure is a step of causing a state of each of second switches to which current is input from a first switch to transition from an off state to a current conduction state in which current flows therethrough; and a step of adjusting an average value of current flowing per unit time for at least one of the second switches, according to one or more second switches that are in the current conduction state.

In the power supply control device, power supply control method, and computer program according to the above aspect, the average value of the current flowing per unit time through at least one second switch is adjusted according to the one or more second switches in a current conduction state. For this reason, the maximum value of the average value of the current flowing through the first switch per unit time is small. As a result, a small switch with a small permissible average value of current can be used as the first switch.

In the power supply control device according to the above aspect, the states of all of the second switches are not fixed in the on state. For this reason, the average value of the current flowing per unit time through the first switch is less than the value of the current flowing through the first switch when the states of the first switch and all of the second switches are fixed in the on state. In the power supply control device according to the above aspect, if the state of the first switch is the on state, the state of the second switch is fixed in the on state or PWM control of the second switch is performed. As a result, the flow of current through the second switch is started.

In the power supply control device according to the above aspect, the switching circuit switches the state of the first switch to the off state if the value of the current flowing through the first switch rises to a value greater than or equal to the current threshold value. This prevents a current with a value greater than or equal to the current threshold value from continuing to flow through the first switch.

In the power supply control device according to the above aspect, if the second switch is a semiconductor switch, a half on failure may occur in the second switch. If a half-on failure occurs in the second switch, the resistance value between both ends of the second switch will not rise to a sufficiently large value even when switching of the second switch to the off state is instructed.

Accordingly, current flows through the second switch, and the value of the voltage between both ends of the second switch is maintained at the value within the predetermined range.

When switching of the second switch to the off state has been instructed, if the period during which the value of the voltage between both ends of the second switch is a value within a predetermined range is greater than or equal to a predetermined period, a half-on failure is considered to have occurred in the second switch, and the processing unit instructs switching of the first switch to the off state. As a result, the state of the first switch is switched to the off state, and the flow of current through the second switch is stopped.

In the power supply control device according to the above aspect, if a half-on failure has occurred in the second switch, when switching of the second switch to the off state is being instructed, the value of the current that flows through the second switch is maintained at a value within a second predetermined range. When switching of the second switch to the off state has been instructed, if the period during which the value of the current flowing through the second switch is a value within the second predetermined range reaches a value greater than or equal to the second predetermined period, a half-on failure is considered to have occurred in the second switch, and the processing unit instructs switching of the first switch to the off state.

In the power supply control device according to the above aspect, there is a possibility that a short-circuit failure will occur in the second switch. If a short-circuit failure has occurred in the second switch, the state of the second switch is maintained in the on state even when switching of the second switch to the off state is instructed. If the state of the second switch is the on state, the value of the voltage between both ends of the second switch is less than the predetermined voltage value. When switching of the second switch to the off state has been instructed, if the value of the voltage between both ends of the second switch is less than the predetermined voltage value, a short-circuit failure is considered to have occurred in the first switch, and switching of the first switch to the off state is instructed.

In the power supply control device according to the above aspect, if a short-circuit failure has occurred in a specific switch, the processing unit instructs switching of the first switch to the off state.

In the power supply control device according to the above aspect, if a short-circuit failure has occurred in a second switch that is not the specific switch, power supply via the second switch in which the short-circuit failure has occurred is permitted. In order to prevent a current with a large value from continuing to flow through the first switch, the average value of the current flowing per unit time through a second switch that is not the second switch in which the short-circuit failure has occurred is reduced.

In the power supply control device according to the above aspect, if a short-circuit failure has occurred in a second switch, even when switching of the second switch to the off state has been instructed, the state of the second switch is maintained in the on state. When the state of the second switch is the on state, if the state of the first switch is the on state, the value of the current flowing through the second switch exceeds the predetermined current value. When switching of the second switch to the off state has been instructed, if the current value flowing through the second switch exceeds a predetermined current value, a short-circuit failure is considered to have occurred in the second switch, and the processing unit instructs switching of the first switch to the off state.

In the power supply control device according to the above aspect, if a short-circuit failure has occurred in a specific switch, the processing unit instructs switching of the first switch to the off state.

In the power supply control device according to the above aspect, if a short-circuit failure has occurred in a second switch that is not the specific switch, power supply via the second switch in which the short-circuit failure has occurred is permitted. In order to prevent a current with a large value from continuing to flow through the first switch, the average value of the current flowing per unit time through a second switch that is not the second switch in which the short-circuit failure has occurred is reduced.

A specific example of a power source system according to an embodiment of the present disclosure will be described below with reference to the drawings. Note that the present disclosure is not limited to these examples, but is indicated by the claims, and is intended to include all modifications within the meaning and scope equivalent to the claims.

### First Embodiment

### Configuration of Power Source System

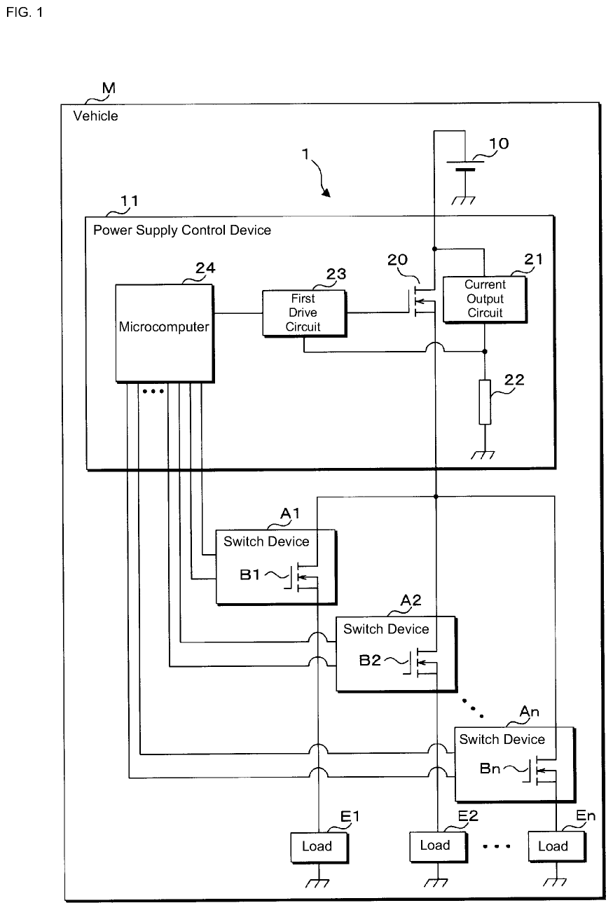

FIG. 1 is a block diagram showing a configuration of a main part of a power source system 1 according to a first embodiment. The power source system 1 is mounted in a vehicle M. The power source system 1 includes a DC power source 10, a power supply control device 11, n switch devices A1, A2, . . . , and An, and n loads E1, E2, . . . , and En. Here, n is an integer greater than or equal to 2. In the following, any natural number less than or equal to n is represented by i. The natural number i may be any one of 1, 2, . . . , and n. The DC power source 10 is, for example, a battery. The power supply control device 11 has a first switch 20. The switch device Ai has a second switch Bi. The first switch 20 and the second switches Bi are N-channel FETs (Field Effect Transistors), and are semiconductor switches.

The negative electrode of DC power source 10 is grounded. Grounding is realized, for example, by connection to the body of the vehicle M. The body is electrically conductive. The positive electrode of the DC power source 10 is connected to the drain of the first switch 20 of the power supply control device 11. The source of the first switch 20 is connected to the drains of the second switches B1, B2, . . . , and Bn. The source of the second switch Bi is connected to one end of the load Ei. The other end of the load Ei is grounded. The power supply control device 11 is individually connected to the n switch devices A1, A2, . . . , and An.

The switch device Ai and the load Ei may also be provided inside a common ECU (Electronic Control Unit). This ECU is called a mechanical and electrical integrated ECU. If the switch device Ai and the load Ei are provided in a common ECU, n ECUs are mounted in the vehicle M. A first example of the load Ei is an electrical device related to a seat, a door, or a wiper. A second example of the load Ei is a light. The type of the load Ei may be the same as or different from the type of another load. The ECU, inside of which is provided an electrical device relating to a seat, is disposed inside or under a driver's seat, passenger seat, or rear seat of the vehicle M, for example.

The power supply control device 11 switches the first switch 20 to an on state or an off state. The switch device Ai switches the second switch Bi to an on state or an off state. If the states of the first switch 20 and the second switch Bi are the on state, the resistance value between the drain and the source is sufficiently small, and current can flow through the drain and the source. If the states of the first switch 20 and the second switch Bi are the off state, the resistance value between the drain and the source is sufficiently large, and no current flows through the drain and the source.

The power supply control device 11 further causes the state of the second switch Bi to transition to a current conduction state or an off state. If the power supply control device 11 fixes the state of the second switch Bi in the on state or performs PWM control of the second switch Bi, the state of the second switch Bi transitions to the current conduction state. PWM is an abbreviation for Pulse Width Modulation. In the PWM control of the second switch Bi, switching of the second switch Bi to the on state and the off state is alternatingly repeated at short intervals. Accordingly, if the state of the second switch Bi is the current conduction state, current can flow through the drain and the source of the second switch Bi.

The power supply control device 11 outputs an on signal to each of the n switching devices A1, A2, . . . , and An. If the on signal has been input, the switch device Ai fixes the state of the second switch Bi in the on state. The power supply control device 11 outputs a PWM signal to each of the n switching devices A1, A2, . . . , and An. The switch device Ai switches the state of the second switch Bi to the on state or the off state according to the input PWM signal.

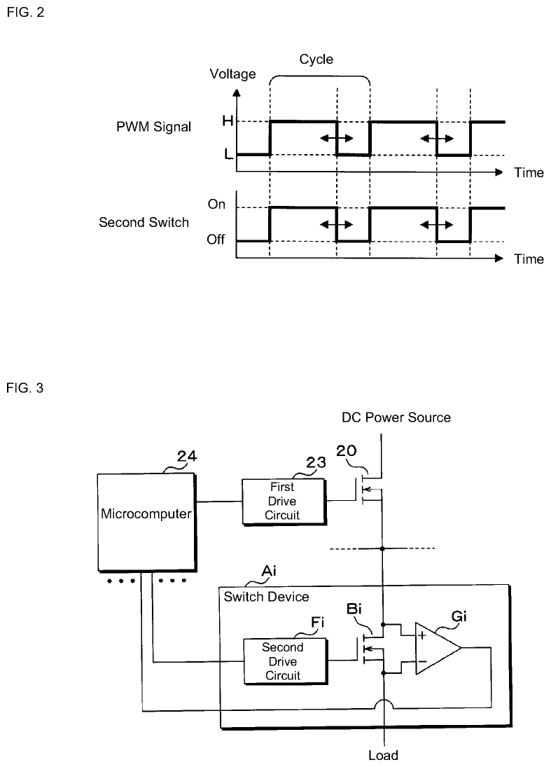

FIG. 2 is an explanatory diagram of switching of the second switch Bi. FIG. 2 shows the change in the voltage indicated by the PWM signal and the change in the state of the second switch Bi. Time is shown on the horizontal axis of these changes. In FIG. 2, a high-level voltage and a low-level voltage are indicated by “H” and “L”, respectively. As shown in FIG. 2, the voltage indicated by the PWM signal is periodically switched from a low-level voltage to a high-level voltage. The percentage that is taken up by a period during which the PWM signal indicates a high-level voltage in one cycle is the duty ratio of the PWM signal. The power supply control device 11 adjusts the duty ratio of the PWM signal by adjusting the timing at which the voltage indicated by the PWM signal switches from a high-level voltage to a low-level voltage.

If the power supply control device 11 has output a PWM signal to the switch device Ai, PWM control of the second switch Bi is performed. The switch device Ai switches the state of the second switch Bi from the off state to the on state when the voltage indicated by the PWM signal switches from a low-level voltage to a high-level voltage. The switch device Ai switches the state of the second switch Bi from the on state to the off state when the voltage indicated by the PWM signal switches from a high-level voltage to a low-level voltage.

Accordingly, the state of the second switch Bi is periodically switched from the off state to the on state. If the timing at which the voltage indicated by the PWM signal switches from a high-level voltage to a low-level voltage has been adjusted, the timing at which the state of the second switch Bi switches from the on state to the off state is adjusted. The percentage taken up in one cycle by the period during which the second switch Bi is in the on state is the duty ratio for PWM control of the second switch Bi. The duty ratio of the second switch Bi is the same as the duty ratio of the PWM signal. The power supply control device 11 adjusts the duty ratio of the second switch Bi by adjusting the duty ratio of the PWM signal.

Note that the power supply control device 11 may also periodically switch the voltage indicated by the PWM signal from a high-level voltage to a low-level voltage. In this case, the power supply control device 11 adjusts the duty ratio of the PWM signal by adjusting the timing of switching the voltage indicated by the PWM signal from a low-level voltage to a high-level voltage. In the PWM control of the second switch Bi, the switch device Ai periodically switches the state of the second switch Bi from the on state to the off state. The switch device Ai adjusts the duty ratio for PWM control of the second switch Bi by adjusting the timing of switching the state of the second switch Bi from the off state to the on state.

The voltage of the on signal is fixed at a high-level voltage. The power supply control device 11 causes the state of the second switch Bi to transition to the current conduction state by outputting an on signal or a PWM signal to the switch device Ai. If the state of the first switch 20 is the on state, when the state of the second switch Bi is the current conduction state, the current flows from the positive electrode of the DC power source 10 to the load Ei through the first switch 20 and the second switch Bi. As a result, power is supplied to the load Ei. When power is supplied to the load Ei, the load Ei operates. When a current flows through the first switch 20 and the second switch Bi, the current is input from the source of the first switch 20 to the drain of the second switch Bi.

If the state of the first switch 20 is the on state, when the power supply control device 11 has output the PWM signal to the switch device Ai, the power supply control device 11 adjusts the average value of the current flowing per unit time through the second switch Bi by adjusting the duty ratio of the PWM signal. The duty ratio of the PWM signal is expressed as D. The value of the current flowing through the second switch Bi when the states of the first switch 20 and the second switch Bi are the on state is referred to as an on-current value. The on-current value is expressed as Ion. The average value of the current flowing through the second switch Bi per unit time is (D·Ion/100) [A]. “·” indicates multiplication. The greater the duty ratio of the PWM signal (PWM control) is, the greater the average value of the current is. The duty ratio D is greater than 0 [%] and less than 100 [%].

If the state of the second switch Bi is fixed in the on state, the average value of the current is the on-current value Ion. When the state of the second switch Bi is fixed in the off state, the average value of the current is 0 [A]. When the power supply control device 11 is outputting a PWM signal to the switch device Ai, the average value of the current exceeds 0 [A] and is less than the on-current value Ion.

The larger the value of the current flowing through the second switch Bi is, the larger the amount of power supplied to the load Ei is. The performance of the load Ei varies depending on the power supplied to load Ei. For example, if the load Ei is a motor, the larger the amount of power supplied to the load Ei is, the higher the rotation speed of the load Ei is.

The power supply control device 11 outputs an off signal to each of the n switching devices A1, A2, . . . , and An. The voltage of the off signal is fixed at a low-level voltage. When the off signal is input, the switch device Ai fixes the state of the second switch Bi in the off state. The power supply control device 11 outputs an off signal to the switch device Ai, thereby causing the state of the second switch Bi to transition to the off state. When the state of the second switch Bi transitions from the current conduction state to the off state, the flow of current through the second switch Bi stops. As a result, the power supply to the load Ei via the second switch Bi stops, and the load Ei stops operating.

If the state of the first switch 20 is the on state, the power supply control device 11 controls the power supply to the load Ei by causing the state of the second switch Bi to transition to the current conduction state or the off state. The power supply control device 11 adjusts the power supplied to the load Ei by adjusting the duty ratio of the PWM signal. When the power supply control device 11 causes the state of the first switch 20 to transition from the on state to the off state, the flow of current through the n second switches B1, B2, . . . , and Bn stops regardless of the states of the n second switches B1, B2, . . . , and Bn.

### Configuration of Power Supply Control Device 11

As shown in FIG. 1, the power supply control device 11 includes, in addition to the first switch 20, a current output circuit 21, a first resistor 22, a first drive circuit 23, and a microcomputer 24. A drain of the first switch 20 is connected to the current output circuit 21. The current output circuit 21 is further connected to one end of the first resistor 22. The other end of the first resistor 22 is grounded. The gate of the first switch 20 is connected to the first drive circuit 23. The first drive circuit 23 is further connected individually to a connection node between the current output circuit 21 and the first resistor 22, and to the microcomputer 24. The microcomputer 24 is individually connected to the n switch devices A1, A2, . . . , and An.

The current output circuit 21 draws current from the drain of the first switch 20 and outputs the drawn current to the first resistor 22. The value of the current flowing through the first switch 20 will be referred to as a first switch current value. The value of the current drawn in by the current output circuit 21 is expressed as (first switch current value)/(predetermined number). The predetermined number is, for example, 1000. All current drawn by the current output circuit 21 flows through the first resistor 22. Accordingly, the value of the voltage between both ends of the first resistor 22 is expressed as (first switch current value). (resistance value of the first resistor 22)/(predetermined number). The resistance value and the predetermined number of the first resistor 22 are constant values. For this reason, the value of the voltage between both ends of the first resistor 22 indicates the first switch current value. The value of the voltage between both ends of the first resistor 22 is output to the first drive circuit 23 as analog current value information representing the first switch current value.

In the first switch 20, when the value of the gate voltage whose reference potential is the potential of the source reaches a value greater than or equal to a certain voltage value, the state of the first switch 20 is switched from the off state to the on state. In the first switch 20, when the value of the gate voltage whose reference potential is the potential of the source reaches a value less than a certain voltage value, the state of the first switch 20 is switched from the on state to the off state.

The microcomputer 24 outputs a high-level voltage or a low-level voltage to the first drive circuit 23. If the first switch current value indicated by the current value information is less than the current threshold value, when the microcomputer 24 switches the voltage being output to the first drive circuit 23 from a low-level voltage to a high-level voltage, the first drive circuit 23 increases the value of the gate voltage of the first switch 20 whose reference potential is the ground potential. As a result, regarding the first switch 20, the value of the gate voltage whose reference potential is the potential of the source increases to a value greater than or equal to a certain voltage value, and the state of the first switch 20 switches to the on state.

If the first switch current value indicated by the current value information is less than the current threshold value, when the microcomputer 24 switches the voltage being output to the first drive circuit 23 from a high-level voltage to a low-level voltage, the first drive circuit 23 lowers the value of the gate voltage of the first switch 20 whose reference potential is the ground potential. As a result, regarding the first switch 20, the value of the gate voltage whose reference potential is the potential of the source decreases to a value less than a certain voltage value, and the state of the first switch 20 switches to the off state.

As described above, the first drive circuit 23 switches the state of the first switch 20 to the on state or the off state. The first drive circuit 23 functions as a switching circuit. The microcomputer 24 instructs switching of the first switch 20 to the on state by switching the voltage being output to the first drive circuit 23 from a low-level voltage to a high-level voltage. In a similar case, the microcomputer 24 instructs switching of the first switch 20 to the off state by switching the voltage being output to the first drive circuit 23 from a high-level voltage to a low-level voltage.

When the first switch current value indicated by the current value information reaches a value greater than or equal to the current threshold value, the first drive circuit 23 switches the state of the first switch 20 to the off state regardless of the voltage that the microcomputer 24 is outputting to the first drive circuit 23. For this reason, current with a value greater than or equal to the current threshold value is prevented from continuing to flow through the first switch 20.

The microcomputer 24 outputs an on signal, an off signal, and a PWM signal to the switch device Ai. The microcomputer 24 adjusts the duty ratio of the PWM signal.

### Configuration of Switch Device Ai

FIG. 3 is a circuit diagram of the switch device Ai. In addition to the second switch Bi, the switch device Ai includes a second drive circuit Fi and a differential amplifier Gi. The differential amplifier Gi has a plus end, a minus end, and an output end. The gate of the second switch Bi is connected to the second drive circuit Fi. The second drive circuit Fi is further connected to the microcomputer 24. The drain and the source of the second switch Bi are respectively connected to the plus end and minus end of the differential amplifier Gi. The output end of the differential amplifier Gi is connected to the microcomputer 24.

In the second switch Bi, when the value of the gate voltage whose reference potential is the potential of the source reaches a value greater than or equal to a certain voltage value, the state of the second switch Bi switches from the off state to the on state. In the second switch Bi, when the value of the gate voltage whose reference potential is the potential of the source reaches a value less than a certain voltage value, the state of the second switch Bi switches from the on state to the off state.

The second drive circuit Fi switches the state of the second switch Bi to the on state by increasing the value of the gate voltage whose reference potential is the ground potential in the second switch Bi. Regarding the second switch Bi, when the value of the gate voltage whose reference potential is the ground potential increases, the value of the gate voltage whose reference potential is the potential of the source increases. Regarding the second switch Bi, when the value of the gate voltage whose reference potential is the potential of the source increases to a value greater than or equal to a certain voltage value, the state of the second switch Bi switches to the on state.

The second drive circuit Fi switches the state of the second switch Bi to the off state by lowering the value of the gate voltage whose reference potential is the ground potential in the second switch Bi. Regarding the second switch Bi, when the value of the gate voltage whose reference potential is the ground potential decreases, the value of the gate voltage whose reference potential is the potential of the source decreases. Regarding the second switch Bi, when the value of the gate voltage whose reference potential is the potential of the source decreases to a value less than a certain voltage value, the state of the second switch Bi switches to the off state.

The microcomputer 24 outputs an on signal, an off signal, and a PWM signal to the second drive circuit Fi. When the microcomputer 24 outputs an on signal to the second drive circuit Fi, the second drive circuit Fi fixes the state of the second switch Bi in the on state. When the microcomputer 24 outputs an off signal to the second drive circuit Fi, the second drive circuit Fi fixes the state of the second switch Bi in the off state. Accordingly, the microcomputer 24 instructs the second drive circuit Fi to switch the second switch Bi to the on state by outputting an on signal to the second drive circuit Fi. The microcomputer 24 instructs the second drive circuit Fi to switch the second switch Bi to the off state by outputting an off signal to the second drive circuit Fi.

If the microcomputer 24 is outputting a PWM signal to the second drive circuit Fi, when the voltage indicated by the PWM signal switches from a low-level voltage to a high-level voltage, the second drive circuit Fi switches the state of the second switch Bi from the off state to the on state. In a similar case, when the voltage indicated by the PWM signal switches from a high-level voltage to a low-level voltage, the second drive circuit Fi switches the state of the second switch Bi from the on state to the off state.

The voltage value between the drain and the source of the second switch Bi will be described as the value of the voltage between both ends of the second switch Bi. The differential amplifier Gi amplifies the voltage between the drain and the source of the second switch Bi, and outputs the amplified voltage to the microcomputer 24. The voltage value that the differential amplifier Gi outputs to the microcomputer 24 is expressed as (value of the voltage between both ends of the second switch Bi). (amplification factor). The amplification factor is a constant value. For this reason, the voltage value that the differential amplifier Gi outputs to the microcomputer 24 functions as analog voltage value information indicating the value of the voltage between both ends of the second switch Bi.

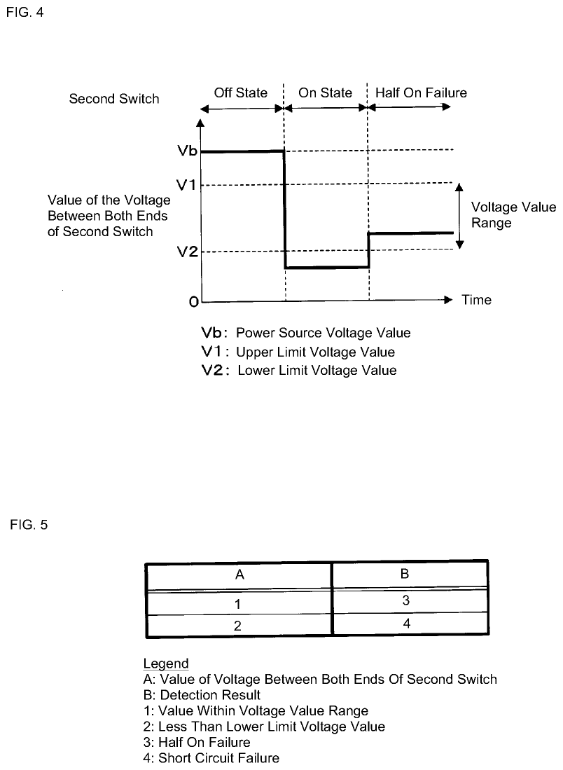

The microcomputer 24 identifies the state of the second switch Bi based on the value of the voltage between both ends of the second switch Bi indicated by the voltage value information. FIG. 4 is an explanatory diagram of the relationship between the value of the voltage between both ends of the second switch Bi and the state of the second switch Bi. FIG. 4 shows the value of the voltage between both ends of the second switch Bi when the state of the first switch 20 is the on state. Hereinafter, the value of the voltage between both ends of the DC power source 10 will be referred to as a power source voltage value. In FIG. 4, the power source voltage value is represented by Vb.

When the state of the second switch Bi is the off state, no current flows through the drain and the source of the second switch Bi. Accordingly, no current flows through the load Ei, and no voltage drop occurs in the load Ei. As a result, the value of the voltage between both ends of the second switch Bi substantially matches the power source voltage value Vb.

If the state of the second switch Bi is the on state, current flows from the positive electrode of the DC power source 10 to the first switch 20, the second switch Bi, and the load Ei, in the stated order. When the second switch Bi is in the on state, the resistance value between the drain and the source of the second switch Bi is sufficiently small. For this reason, the value of the voltage between both ends of the second switch Bi is close to 0 [V].

A half-on failure may occur in the second switch Bi. If a half-on failure occurs in the second switch Bi, even when the second drive circuit Fi is instructed to switch the second switch Bi to the off state, the resistance value between the drain and the source of the second switch Bi does not rise to a sufficiently large value. Accordingly, current continues to flow through the drain and the source of the second switch Bi, and the value of the voltage between both ends of the second switch Bi is maintained at a value within a certain voltage value range. In FIG. 4, the upper limit voltage value and lower limit voltage value of the voltage value range are indicated by V1 and V2, respectively. The upper limit voltage value V1 is less than the power source voltage value Vb. The lower limit voltage value V2 exceeds the value of the voltage between both ends of the second switch Bi when the second switch Bi is in the on state. A value within the voltage value range is less than or equal to the upper limit voltage value V1 and greater than or equal to the lower limit voltage value V2. The voltage value range corresponds to a predetermined range. The upper limit voltage value V1 and the lower limit voltage value V2 are determined in advance.

A short-circuit failure may occur in the second switch Bi. If a short-circuit failure occurs in the second switch Bi, even when the microcomputer 24 instructs the second drive circuit Fi to switch the second switch Bi to the off state, the second switch Bi is maintained in an on state. If the state of the second switch Bi is the on state, the value of the voltage between both ends of the second switch Bi is less than the lower limit voltage value V2.

FIG. 5 is a chart for describing a method of detecting a failure of the second switch Bi. When the state of the first switch 20 is the on state, the microcomputer 24 acquires voltage value information when switching of the second switch Bi to the off state has been instructed. If the value of the voltage between both ends of the second switch Bi indicated by the acquired voltage value information is within the voltage value range, the microcomputer 24 acquires the voltage value information again. The period during which the value of the voltage between both ends of the second switch Bi is maintained within the voltage value range is referred to as the unstable period of the second switch Bi. The microcomputer 24 detects a half-on failure of the second switch Bi if the unstable period of the second switch Bi is greater than or equal to a predetermined period. The microcomputer 24 detects a short-circuit failure of the second switch Bi if the value of the voltage between both ends of the second switch Bi indicated by the acquired voltage value information is less than the lower limit voltage value V2.

The microcomputer 24 causes the state of the second switch Bi to transition to the off state or the current conduction state by outputting an on signal, an off signal, and a PWM signal to the second drive circuit Fi. The microcomputer 24 adjusts the average value of the current flowing per unit time through one or more second switches that are in the current conduction state among the n second switches B1, B2, . . . , and Bn such that the average value of the current flowing per unit time through the first switch 20 is less than a predetermined current value. The predetermined current value is less than or equal to the current threshold value described above.

If a half-on failure is detected in at least one of the n second switches B1, B2, . . . , and Bn, the microcomputer 24 instructs the first drive circuit 23 to switch the first switch 20 to the off state. One or more specific switches are included among the n second switches B1, B2, . . . , and Bn. The one or more specific switches are determined in advance. If a short-circuit failure is detected in at least one specific switch, the microcomputer 24 instructs the first drive circuit 23 to switch the first switch 20 to the off state.

If a short-circuit failure is detected in a second switch that is not the one or more specific switches among the n second switches B1, B2, . . . , and Bn, the microcomputer 24 does not instruct the first drive circuit 23 to switch the first switch 20 to the off state. The microcomputer 24 reduces the average value of the current flowing per unit time through second switches that are in the current conduction state and are not the second switch with the short-circuit failure, such that the average value of the current flowing per unit time through the first switch 20 is less than a predetermined current value.

### Configuration of Microcomputer 24

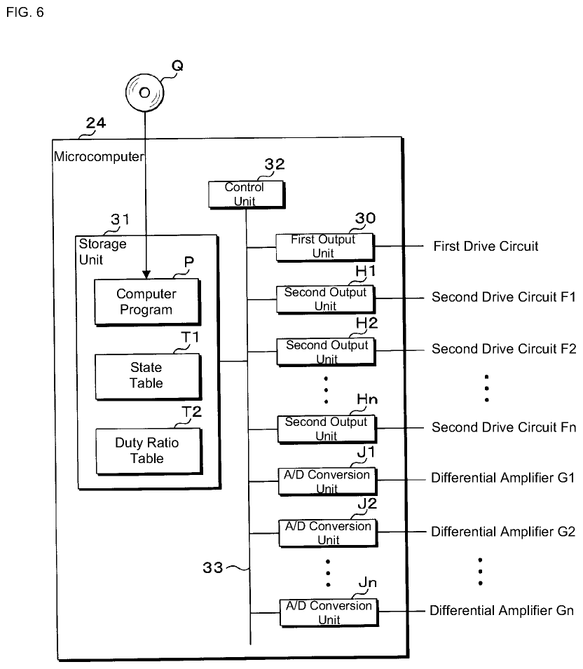

FIG. 6 is a block diagram showing a configuration of a main part of the microcomputer 24. The microcomputer 24 includes a first output unit 30, a storage unit 31, a control unit 32, n second output units H1, H2, . . . , and Hn, and n A/D conversion units J1, J2, . . . , and Jn. These are connected to an internal bus 33. The first output unit 30 is further connected to the first drive circuit 23. The second output unit Hi is further connected to the second drive circuit Fi. The A/D conversion unit Ji is further connected to the output end of the differential amplifier Gi.

The first output unit 30 outputs a high-level voltage or a low-level voltage to the first drive circuit 23. The control unit 32 instructs the first output unit 30 to change the voltage being output to the first drive circuit 23 to a high-level voltage or a low-level voltage.

The control unit 32 instructs the second output unit Hi to cause the second drive circuit Fi to output an on signal, an off signal, or a PWM signal. In the second output unit Hi, the duty ratio of the PWM signal is stored. The control unit 32 changes the duty ratio of the PWM signal stored in the second output unit Hi. When the second output unit Hi is outputting a PWM signal, the second output unit Hi adjusts the duty ratio of the PWM signal to the duty ratio stored in the second output unit Hi.

The differential amplifier Gi of the switch device Ai outputs analog voltage value information to the A/D conversion unit Ji. The A/D conversion unit Ji converts the analog voltage value information input from the differential amplifier Gi into digital voltage value information. The control unit 32 acquires the digital voltage value information converted by the A/D conversion unit Ji.

The storage unit 31 is constituted by, for example, a volatile memory and a nonvolatile memory. A computer program P is stored in the storage unit 31. The control unit 32 has a processing element that executes processing, and functions as a processing unit. The processing element is, for example, a CPU (Central Processing Unit). By executing the computer program P, the processing element (computer) of the control unit 32 executes power supply control processing for the loads E1, E2, . . . , and En, switching processing for the first switch 20, and the like in parallel. The power supply control processing for the load Ei is processing for controlling the power supply to the load Ei. The switching processing for the first switch 20 is processing for switching the state of the first switch 20 to the on state or the off state.

Note that the computer program P may also be provided to the microcomputer 24 using a non-temporary storage medium Q that readably stores the computer program P. The storage medium Q is, for example, a portable memory. Examples of the portable memory include a CD-ROM, a USB (Universal Serial Bus) memory, an SD card, a micro SD card, Compact Flash (registered trademark), and the like. If the storage medium Q is a portable memory, the processing element of the control unit 32 may read the computer program P from the storage medium Q using a reading device (not shown). The read computer program P is written into the storage unit 31. Furthermore, the computer program P may also be provided to the microcomputer 24 by a communication unit (not shown) of the microcomputer 24 communicating with an external device. In this case, the processing element of the control unit 32 obtains the computer program P through the communication unit. The acquired computer program P is written into the storage unit 31.

Furthermore, the number of processing elements that the control unit 32 has is not limited to one, and may be two or more. If the control unit 32 has a plurality of processing elements, the plurality of processing elements may cooperate to execute the power supply processing for the loads E1, E2, . . . , and En, the switching processing for the first switch 20, and the like.

The storage unit 31 stores a state table T1 and a duty ratio table T2. The state table T1 shows the states of the n second switches B1, B2, . . . , and Bn. The duty ratio table T2 indicates the relationship between the states of the n second switches B1, B2, . . . , and Bn, and the duty ratio for PWM control of the n second switches B1, B2, . . . , and Bn.

### Description of State Table T1

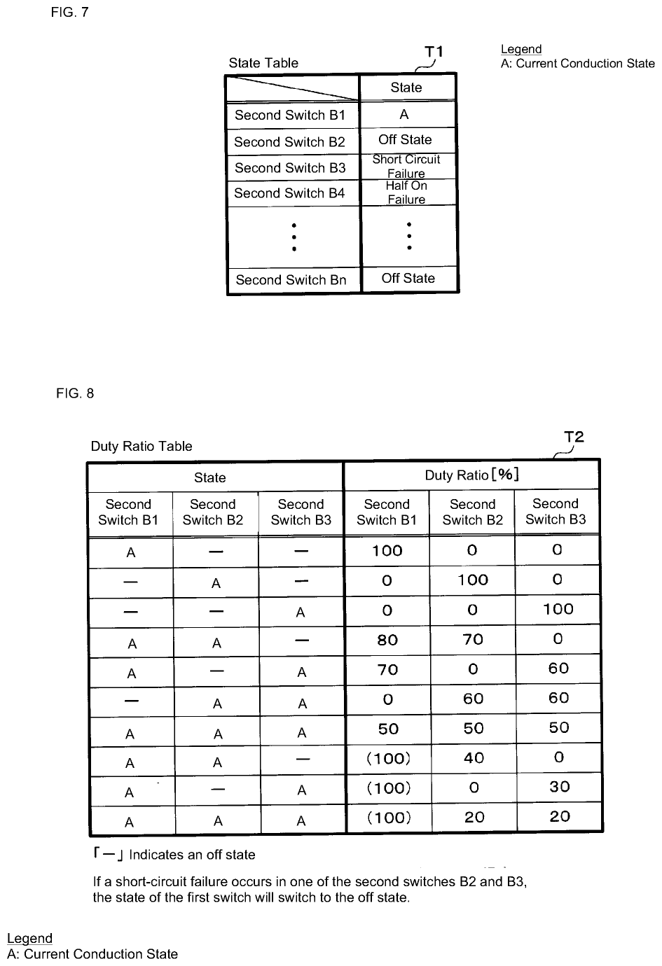

FIG. 7 is a chart showing the content of the state table T1. As described above, the state table T1 indicates the states of the n second switches B1, B2, . . . , and Bn. As the state of the second switch Bi, one of a current conduction state, an off state, a short-circuit failure, and a half-on failure is shown. The state of the second switch Bi shown in the state table T1 is changed by the control unit 32.

### Description of Duty Ratio Table T2

FIG. 8 is a chart showing the content of the duty ratio table T2. In the duty ratio table T2, n duties corresponding to the states of the second switches B1, B2, . . . , and Bn are shown. The duties of the duty ratio table T2 are the duties of PWM control of the second switch Bi. In FIG. 8, “·” indicates an off state.

As described above, the duty ratio for PWM control is greater than 0 [%] and less than 100 [%]. In the duty ratio table T2, a duty ratio of 100 [%] indicates that the second switch Bi is fixed in the on state. A duty ratio of 0 [%] indicates that the second switch Bi is fixed in the off state. A duty ratio of (100) indicates that the second switch Bi is fixed in the on state due to a short-circuit failure.

In FIG. 8, an example of a duty ratio table T2 in which the integer n is 3 is shown. If a half-on failure or a short-circuit failure has not occurred, when one of the three second switches B1, B2, and B3 is in the current conduction state, the state is fixed in the on state. If two of the three second switches B1, B2, and B3 are in the current conduction state, PWM control is performed for each of the second switches in the current conduction state. If the three second switches B1, B2, and B3 are in the current conduction state, PWM control is performed for each of the three second switches B1, B2, and B3.

If a half-on failure or a short-circuit failure has not occurred, the duty ratio for PWM control of each of the second switches B1, B2, and B3 decreases the higher the number of second switches in the current conduction state is. For example, if the number of second switches in the current conduction state is two, the duty ratio for PWM control of the second switch B1 is 80 [%] or 70 [%]. If the number of second switches in the current conduction state is three, the duty ratio for PWM control of the second switch B1 is 50 [%].

If a short-circuit failure occurs in the second switch B1, current flow through the second switches B2 and B3 is permitted. When one or both of the second switches B2 and B3 is in the current conduction state, PWM control of the second switch in the current conduction state is performed.

It is assumed that the states of a plurality of the second switches among the three second switches B1, B2, and B3 are the current conduction state if a half-on failure or a short-circuit failure has not occurred. In this case, if the state of one second switch transitions from the current conduction state to a short-circuit failure, the duty ratio for PWM control of the second switch in the current conduction state decreases. In the example of FIG. 8, if a half-on failure or a short-circuit failure has not occurred, when the two second switches B1 and B2 are in a current conduction state, the duty ratio for PWM control of the second switch B2 is 70 [%]. If the state of the second switch B1 transitions from the current conduction state to a short-circuit failure, the duty ratio for PWM control of the second switch B2 decreases from 70 [%] to 40 [%].

If a half-on failure or a short-circuit failure has not occurred, when the three second switches B1, B2, and B3 are in a current conduction state, the duty ratio for PWM control of each of the second switches B2 and B3 is 50 [%]. If the state of the second switch B1 transitions from the current conduction state to a short-circuit failure, the duty ratio for PWM control of each of the second switches B2 and B3 decreases from 50 [%] to 20 [%].

In the example of FIG. 8, if a short-circuit failure occurs in one of the second switches B2 and B3, the state of the first switch 20 switches from the on state to the off state. For this reason, the three duties in the case where the state of at least one of the second switches B2 and B3 is a short-circuit failure are not shown. In the example of FIG. 8, each of the second switches B2 and B3 is a specific switch.

### Power Supply Control Processing for Load E1

The power supply control processing for each of the loads E1, E2, . . . , and En is executed by the control unit 32 when the state of the first switch 20 is the on state. In the power supply control processing for the load Ei, the control unit 32 changes the state of the second switch Bi in the state table T1. For this reason, there is a possibility that the state of one of the second switches B2, B3, . . . , and Bn will be changed while executing the power supply control processing for the load E1.

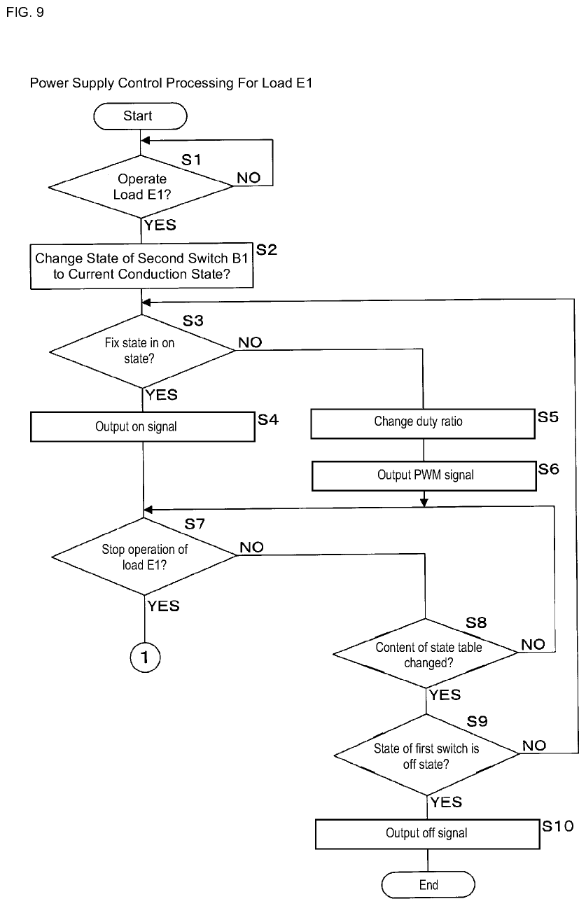

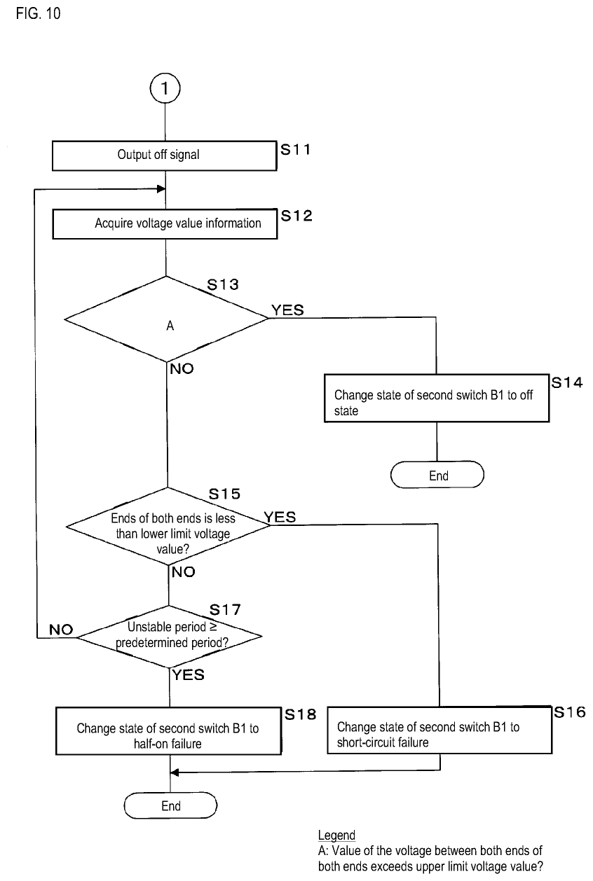

FIGS. 9 and 10 are flowcharts showing a procedure of power supply control processing for the load E1. In the power supply control processing for the load E1, the control unit 32 first determines whether or not the load E1 is to be operated (step S1). If the control unit 32 determines that the load E1 is not to be operated (S1: NO), the control unit 32 executes step S1 again. The control unit 32 waits until a timing of operating the load E1 arrives.

If the control unit 32 determines that the load E1 is to be operated (S1: YES), the control unit 32 changes the state of the second switch B1 from the off state to the current conduction state in the state table T1 (step S2). Next, the control unit 32 determines whether or not to fix the state of the second switch B1 in the on state based on the state table T1 and the duty ratio table T2 (step S3).

If the duty ratio table T2 shown in FIG. 8 is used, when the states of the second switches B2 and B3 are the off state in the state table T1, the control unit 32 determines in step S3 that the state of the second switch B1 is to be fixed in the on state. In a similar case, when at least one of the second switches B2 and B3 is in the current conduction state in the state table T1, the control unit 32 determines in step S3 that the state of the second switch B1 is not to be fixed in the on state.

If the control unit 32 determines that the state of the second switch B1 is to be fixed in the on state (S3: YES), the control unit 32 instructs the second output unit H1 to output an on signal to the second drive circuit F1 (step S4). As a result, the second drive circuit F1 fixes the state of the second switch B1 in the on state.

If the control unit 32 determines that the state of the second switch B1 is not to be fixed in the on state (S3: NO), the control unit 32 changes the duty ratio stored in the first output unit 30 based on the state table T1 and the duty ratio table T2 (step S5). If the duty ratio table T2 shown in FIG. 8 is used, when the states of the second switches B2 and B3 are respectively the current conduction state and the off state in the state table T1, for example, in step S5, the control unit 32 changes the duty ratio to 80 [%].

After executing step S5, the control unit 32 instructs the second output unit H1 to output the PWM signal to the second drive circuit F1 (step S6). As a result, the second drive circuit F1 performs PWM control of the second switch B1 in accordance with the PWM signal input from the second output unit H1. The duty ratio for PWM control is the duty ratio changed in step S5, that is, the duty ratio shown in the duty ratio table T2. When the second switch B1 is in the current conduction state, power is supplied to the load E1, and the load E1 operates.

After executing one of steps S4 and S6, the control unit 32 determines whether or not to stop the operation of the load E1 (step S7). If the control unit 32 determines that the operation of the load E1 is not to be stopped (S7: NO), the control unit 32 determines whether or not the content of the state table has been changed (step S8). If the control unit 32 determines that the content of the state table has not been changed (S8: NO), the control unit 32 executes step S7. The control unit 32 waits until the timing of stopping the operation of the load E1 arrives or until the content of the state table is changed.

If the control unit 32 determines that the content of the state table has been changed (S8: YES), the control unit 32 determines whether or not the state of the first switch 20 is the off state based on the changed state table (step S9). As described above, if a half-on failure is detected in at least one of the n second switches B1, B2, . . . , and Bn, the state of the first switch 20 is switched to the off state. Furthermore, if a short-circuit failure is detected in at least one specific switch, the state of the first switch 20 is switched to the off state.

Accordingly, if the state of at least one of the second switches B2, B3, . . . , and Bn indicates a half-on failure in the state table, in step S9, the control unit 32 determines that the state of the first switch 20 is the off state. Furthermore, if the state of at least one specific switch is a short-circuit failure in the state table, in step S9, the control unit 32 determines that the state of the first switch 20 is the off state.

If the control unit 32 determines that the state of the first switch 20 is not the off state (S9: NO), the control unit 32 executes step S3 again. The second output unit H1 outputs an on signal or a PWM signal to the second drive circuit F1 according to the state table T1 and the duty ratio table T2.

In the case where the duty ratio table T2 shown in FIG. 8 is used, it is assumed that the states of the second switches B2 and B3 were the current conduction state and the off state, respectively, in the state table T1. In the state table T1, when the state of the second switch B2 has been changed to the off state, the control unit 32 executes step S4, and the second output unit H1 outputs an on signal. Also, when the duty ratio table T2 shown in FIG. 8 is used, it is assumed that the states of the second switches B2 and B3 were the off state in the state table T1. In the state table T1, when the state of the second switch B3 is changed to the current conduction state, the control unit 32 executes steps S5 and S6, and the second output unit H1 outputs a PWM signal with a duty ratio of 70 [%].

If the control unit 32 determines that the state of the first switch 20 is the off state (S9: YES), the control unit 32 instructs the second output unit H1 to output an off signal to the second drive circuit F1 (step S10). As a result, the state of the second switch B1 is fixed in the off state. After executing step S10, the control unit 32 ends the power supply control processing for the load E1. In this case, the control unit 32 does not execute the power supply control processing for the load E1 again.

If the control unit 32 determines that the operation of the load E1 is to be stopped (S7: YES), the control unit 32 instructs the second output unit H1 to output an off signal to the second drive circuit F1 (step S11). The control unit 32 instructs the second drive circuit F1 to switch the second switch B1 to the off state by executing step S11. After executing step S11, the control unit 32 acquires voltage value information from the A/D conversion unit J1 (step S12).

Next, the control unit 32 determines whether or not the value of the voltage between both ends of the second switch B1 indicated by the voltage value information acquired in step S12 exceeds the upper limit voltage value of the voltage value range (step S13). As shown in FIG. 4, if the state of the second switch B1 is fixed in the off state, the value of the voltage between both ends of the second switch B1 exceeds the upper limit voltage value V1. If the control unit 32 determines that the value of the voltage between both ends of the second switch B1 exceeds the upper limit voltage value (S13: YES), the control unit 32 changes the state of the second switch B1 to the off state in the state table T1 (step S14), and the power supply control processing for the load E1 is ended. In this case, when the first switch 20 is in the on state, the control unit 32 again executes the power supply control processing for the load E1.

If the control unit 32 determines that the value of the voltage between both ends of the second switch B1 is less than or equal to the upper limit voltage value (S13: NO), the control unit 32 determines whether or not the value of the voltage between both ends of the second switch B1 indicated by the voltage value information acquired in step S12 is less than the lower limit voltage value of the value range (step S15). As stated in the description of FIG. 5, if the value of the voltage between both ends of the second switch B1 is less than the lower limit voltage value, a short-circuit failure has occurred in the second switch B1. If the control unit 32 determines that the value of the voltage between both ends of the second switch B1 is less than the lower limit voltage value (S15: YES), the control unit 32 changes the state of the second switch B1 to a short-circuit failure in the state table T1 (step S16).

If the control unit 32 determines that the value of the voltage between both ends of the second switch B1 is greater than or equal to the lower limit voltage value (S15: NO), the control unit 32 determines whether or not the unstable period of the second switch B1 is greater than or equal to a predetermined period determined in advance (step S17). As described above, the unstable period of the second switch B1 is a period during which the value of the voltage between both ends of the second switch B1 is maintained at a value within the voltage value range. The unstable period is measured, for example, by a timer (not shown). The starting point of the unstable period is, for example, the time when step S11 is executed. As stated in the description of FIG. 5, if the unstable period of the second switch B1 is greater than or equal to the predetermined period, a half-on failure has occurred in the second switch B1.

If the control unit 32 determines that the unstable period is less than the predetermined period (S17: NO), the control unit 32 executes step S12 again. The control unit 32 determines again whether or not the value of the voltage between both ends of the second switch B1 indicated by the newly-acquired voltage value information is a value within the voltage value range. If the control unit 32 determines that the unstable period is greater than or equal to the predetermined period (S17: YES), the control unit 32 changes the state of the second switch B1 to a half-on failure in the state table T1 (step S18). If the control unit 32 has executed one of steps S16 and S18, the control unit 32 ends the power supply control processing for the load E1. In this case, the control unit 32 does not execute the power supply control processing for the load E1 again.

### Power Supply Control Processing for Loads E2, E3, . . . , En

The power supply control processing for the respective loads E2, E3, . . . , and En is executed by the control unit 32, similarly to the power supply control processing for the load E1. Any integer greater than or equal to 2 and less than or equal to n is written as k. The integer k may be any of 2, 3, . . . , and n. The load E1, the second switch B1, the second drive circuit F1, and the second output unit H1, which are described in the description of the power supply control processing for the load E1, respectively correspond to the load Ek, the second switch Bk, the second drive circuit Fk, and the second output unit Hk in the description of the power supply control processing for the load Ek.

In the case where the duty ratio table T2 shown in FIG. 8 is used, when the state of the second switch B1 changes to a short-circuit failure in the state table T1, the state of the first switch 20 does not switch to the off state. For this reason, for example, in the power supply control processing for the load E2, the state of the second switch B2 is maintained in the current conduction state. In the state table T1, if the state of the second switch B1 is changed from the current conduction state to a short-circuit failure, the control unit 32 changes the duty ratio for PWM control of the second switch B2 from 70 [%] to 40 [%], as shown in FIG. 8.

### Effect of Power Supply Control Processing for Loads E1, E2, . . . , En

If the power supply control processing for the loads E1, E2, . . . , and En has been executed, the control unit 32 adjusts the average value of the current flowing per unit time through the second switch Bi according to the one or more second switches in the current conduction state. For this reason, the maximum value of the average value of the current flowing per unit time through the first switch 20 is small. As a result, a small switch with a small permissible average current value can be used as the first switch 20.

As described above, the control unit 32 adjusts the average value of the current flowing per unit time through the second switch Bi. For this reason, the states of all of the n second switches B1, B2, . . . , and Bn are not fixed in the on state. As a result, the maximum value of the average value of the current flowing per unit time through the first switch 20 is less than the value of the current that would flow through the first switch 20 if the states of the first switch 20 and the n second switches B1, B2, . . . , and Bn were fixed in the on state.

Also, the control unit 32 instructs the second output unit Hi to cause the second drive circuit Fi to output an off signal, thereby causing the second switch Bi to transition to the off state. The control unit 32 instructs the second output unit Hi to cause the second drive circuit Fi to output an on signal or a PWM signal, thereby causing the state of the second switch Bi to transition to the current conduction state. When the second output unit Hi outputs an on signal to the second drive circuit Fi, the state of the second switch Bi is fixed in the on state. When the second output unit Hi outputs a PWM signal to the second drive circuit Fi, PWM control of the second switch Bi is performed. In the case where the state of the first switch 20 is the on state, when the state of the second switch Bi is fixed in the on state or PWM control of the second switch Bi is performed, current begins to flow through the second switch Bi.

### Switching Processing for First Switch 20

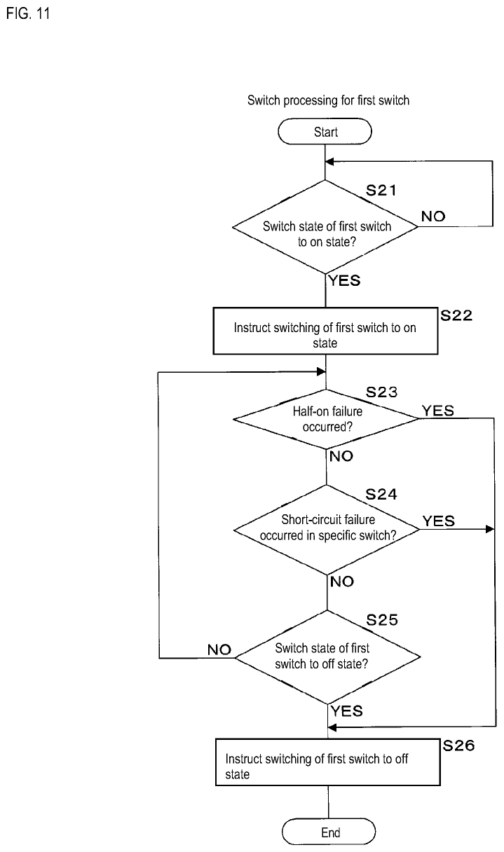

FIG. 11 is a flowchart showing a procedure of switching processing for the first switch 20. In the switching processing for the first switch 20, the control unit 32 determines whether or not to switch the state of the first switch 20 from the off state to the on state (step S21). The microcomputer 24 may also have a signal input unit into which a signal is input from outside the power supply control device 11. In step S21, the control unit 32 determines that the state of the first switch 20 is to be switched to the on state, for example, if a signal indicating switching of the first switch 20 to the on state has been input to the signal input unit.

If the control unit 32 determines that the state of the first switch 20 is not to be switched to the on state (S21: NO), the control unit 32 executes step S21 again. The control unit 32 waits until the timing of switching the state of the first switch 20 to the on state arrives. If the control unit 32 determines that the state of the first switch 20 is to be switched to the on state (S21: YES), the control unit 32 instructs the first drive circuit 23 to switch the first switch 20 to the on state (step S22). Specifically, the control unit 32 instructs the first output unit 30 to switch the voltage being output to the first drive circuit 23 to a high-level voltage.

After executing step S22, the control unit 32 determines whether or not a half-on failure has occurred in at least one of the n second switches B1, B2, and Bn based on the state table T1 (step S23). If the control unit 32 determines that a half-on failure has not occurred (S23: NO), the control unit 32 determines whether or not a short-circuit failure has occurred in at least one of the one or more specific switches based on the state table T1 (step S24). When the duty ratio table T2 shown in FIG. 8 is used, the second switches B2 and B3 are the specific switches.

A specific switch is, for example, a second switch that is connected to a load that may impede driving of the vehicle M if operation is continued. A second switch that is not a specific switch is connected to a load such as a headlight or a wiper motor that does not interfere with the driving of the vehicle M even if operation is continued.

If the control unit 32 determines that a short-circuit failure has not occurred in any of the specific switches (S24: NO), the control unit 32 determines whether or not to switch the state of the first switch 20 to the off state (step S25). In step S25, in the case where the states of the n second switches B1, B2, . . . , and Bn are the off state, for example, when an off signal indicating switching of the first switch 20 to the off state is input to the signal input unit, the control unit 32 determines that the state of the first switch 20 is to be switched to the on state.

If the control unit 32 determines that the state of the first switch 20 is not to be switched to the off state (S25: NO), the control unit 32 executes step S23 again. If the control unit 32 determines that a half-on failure has occurred (S23: YES), if the control unit 32 determines that a short-circuit failure has occurred in at least one of the one or more specific switches (S24: YES), or if the control unit 32 determines that the state of the first switch 20 is to be switched to the on state (S25: YES), the control unit 32 instructs the first drive circuit 23 to switch the first switch 20 to the off state (step S26). Specifically, the control unit 32 instructs the first output unit 30 to switch the voltage being output to the first drive circuit 23 to a low-level voltage.

After executing step S26, the control unit 32 ends the switching processing for the first switch 20. If the control unit 32 ends the switching processing for the first switch 20 after determining that a half-on failure has occurred in step S23 or after determining that a short-circuit failure has occurred in step S24, the control unit 32 does not execute the switching processing for the first switch 20 again. If the control unit 32 ends the switching processing for the first switch 20 after determining in step S25 that the state of the first switch 20 is to be switched to the off state, the control unit 32 executes the switching processing for the first switch 20 again.

As described above, in the power supply control processing for the load Ei, when the control unit 32 instructs the second drive circuit Fi to switch the second switch Bi to the off state, if the unstable period of the second switch Bi becomes a value greater than or equal to a predetermined period, the control unit 32 changes the state of the second switch Bi to a half-on failure in the state table T1. In the switching processing for the first switch 20, the control unit 32 instructs the first drive circuit 23 to switch the first switch to the off state when the state of at least one of the n second switches B1, B2, . . . , and Bn has been changed to a half-on failure in the state table T1. As a result, the state of the first switch 20 is switched to the off state, and the flow of current through the second switches B1, B2, . . . , and Bn is stopped.

The amount of heat generated when current flows through a second switch in which a half-on failure has occurred is large. For this reason, if current continues to flow through the second switch in which the half-on failure has occurred, the temperature of the second switch in which the half-on failure has occurred may rise to an abnormal temperature. As described above, when a half-on failure occurs in the second switch Bi, the flow of current through the second switch Bi is stopped. For this reason, the temperature of the second switch Bi is prevented from rising to an abnormal temperature.

Also, in the power supply control processing for the load Ei, when the control unit 32 instructs the second drive circuit Fi to switch the second switch Bi to the off state, the control unit 32 changes the state of the second switch Bi to a short-circuit failure in the state table T1 if the value of the voltage between both ends of the second switch Bi is less than the lower limit voltage value. In the switching processing for the first switch 20, the control unit 32 instructs the first drive circuit 23 to switch off the first switch when the state of the specific switch has been changed to a short-circuit failure in the state table T1. The lower limit voltage value corresponds to the predetermined voltage value.

When the state of a second switch that is not the specific switch is changed to a short-circuit failure in the state table T1, the control unit 32 lowers the average value of the current flowing per unit time through the second switch that is in the current conduction state and is not the specific switch. When a short-circuit failure has occurred in a second switch that is not the specific switch, power supply via the second switch in which the short-circuit failure has occurred is permitted. In order to prevent a current with a large value from continuing to flow through the first switch 20, the average value of the current flowing per unit time through the second switch in the current conduction state is reduced.

### Second Embodiment

In the first embodiment, the value of the voltage between both ends of the second switch Bi is used to detect a failure of the second switch Bi. However, the parameter used to detect a failure of the second switch Bi is not limited to the value of the voltage between both ends of the second switch Bi. As described in the first embodiment, i is any natural number less than or equal to n.

Hereinafter, the differences from the first embodiment regarding the second embodiment will be described. Other configurations excluding those described below are the same as those of the first embodiment, and therefore the same reference numerals as those of the first embodiment are given to the constituent parts that are common to the first embodiment, and description thereof is omitted.

### Configuration of Switch Device Ai

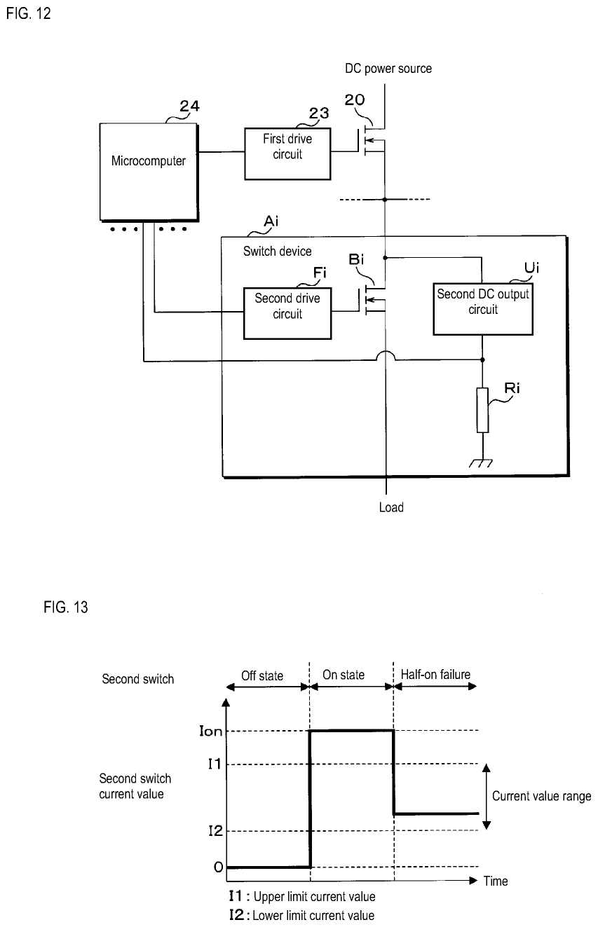

FIG. 12 is a circuit diagram of the switch device Ai in the second embodiment. Similarly to the first embodiment, the switch device Ai in the second embodiment includes a second switch Bi and a second drive circuit Fi. The switch device Ai in the second embodiment further includes a second current output circuit Ui and a second resistor Ri instead of the differential amplifier Gi. The drain of the second switch Bi is connected to the second current output circuit Ui. The second current output circuit Ui is further connected to one end of the second resistor Ri. The other end of the second resistor Ri is grounded. A connection node between the second current output circuit Ui and the second resistor Ri is connected to the A/D conversion unit Ji of the microcomputer 24.

The second current output circuit Ui draws current from the drain of the second switch Bi and outputs the drawn current to the second resistor Ri. The value of the current flowing through the second switch Bi will be referred to as a second switch current value. The current value drawn by the second current output circuit Ui is expressed as (second switch current value)/(second predetermined number). The second predetermined number is, for example, 1000. All of the current drawn by the second current output circuit Ui flows through the second resistor Ri. Accordingly, the value of the voltage between both ends of the second resistor Ri is expressed as (second switch current value) (resistance value of second resistor Ri)/(second predetermined number). The resistance value of the second resistor Ri and the second predetermined number are constant values. For this reason, the value of the voltage between both ends of the second resistor Ri indicates the second switch current value. The value of the voltage between both ends of the second resistor Ri is output to the A/D conversion unit Ji of the microcomputer 24 as analog second current value information representing the second switch current value.

The A/D conversion unit Ji converts the analog second current value information input from the connection node between the second current output circuit Ui and the second resistor Ri into digital second current value information. The control unit 32 of the microcomputer 24 acquires the digital second current value information converted by the A/D conversion unit Ji.

The control unit 32 of the microcomputer 24 specifies the state of the second switch Bi based on the second switch current value indicated by the second current value information. FIG. 13 is an explanatory diagram of the relationship between the second switch current value and the state of the second switch Bi. FIG. 13 shows the second switch current value of the second switch Bi when the state of the first switch 20 is the on state.

When the state of the second switch Bi is the off state, the second switch current value is 0 [A]. As stated in the description of the first embodiment, when the states of the first switch 20 and the second switch Bi are the on state, the second switch current value is the on-current value. The on-current value is sufficiently large. The on-current value is expressed as Ion. The resistance value between the drain and the source of the first switch 20 in the on state is referred to as a first on-resistance value. The resistance value between the drain and the source of the second switch Bi in the on state is referred to as a second on-resistance value. The resistance value of the load Ei is written as “load resistance value”. The on-current value Ion is expressed as (power source voltage value)/((first on-resistance value)+ (second on-resistance value)+ (load resistance value)).

As stated in the description of the first embodiment, if a half-on failure has occurred in the second switch Bi, even when the second drive circuit Fi is instructed to switch the second switch Bi to the off state, the resistance value between the drain and the source of the second switch Bi does not rise to a sufficiently large value. Accordingly, current continues to flow through the drain and the source of the second switch Bi.

In FIG. 13, the upper limit current value and the lower limit current value of the current value range are indicated by I1 and I2, respectively. The current value range corresponds to a second predetermined range. The upper limit current value I1 is less than the on-current value Ion. The lower limit current value I2 exceeds 0 [A]. A value within the current value range is less than or equal to the upper limit current value I1 and greater than or equal to the lower limit current value I2. The upper limit current value I1 and the lower limit current value I2 are determined in advance. If a half-on failure has occurred in the second switch Bi, when switching of the second switch Bi to the off state has been instructed, the value of the current flowing through the second switch Bi is maintained at a value within the second predetermined range.

As stated in the description of the first embodiment, if a short-circuit failure has occurred in the second switch Bi, the state of the second switch Bi is maintained in an on state even when the microcomputer 24 instructs the second drive circuit Fi to switch the second switch Bi to the off state. If the second switch Bi is in an on state, the second switch current value is the on-current value Ion, which exceeds the upper limit current value I1.

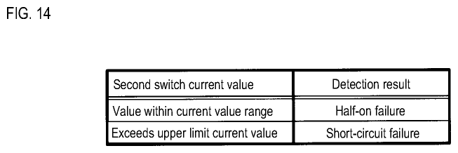

FIG. 14 is a chart for describing a method for detecting a failure of the second switch Bi. When the state of the first switch 20 is the on state, the control unit 32 of the microcomputer 24 acquires current value information from the A/D conversion unit Ji when switching of the second switch Bi to the off state has been instructed. If the second switch current value indicated by the acquired current value information is within the current value range, the control unit 32 acquires the current value information again.

In the second embodiment, the unstable period of the second switch Bi is a period during which the second switch current value of the second switch Bi is maintained at a value within the current value range. The control unit 32 detects a half-on failure of the second switch Bi when the unstable period is greater than or equal to the second predetermined period. The control unit 32 detects a short-circuit failure of the second switch Bi if the second switch current value indicated by the acquired current value information exceeds the upper limit current value I1.

### Power Supply Control Processing for Load E1

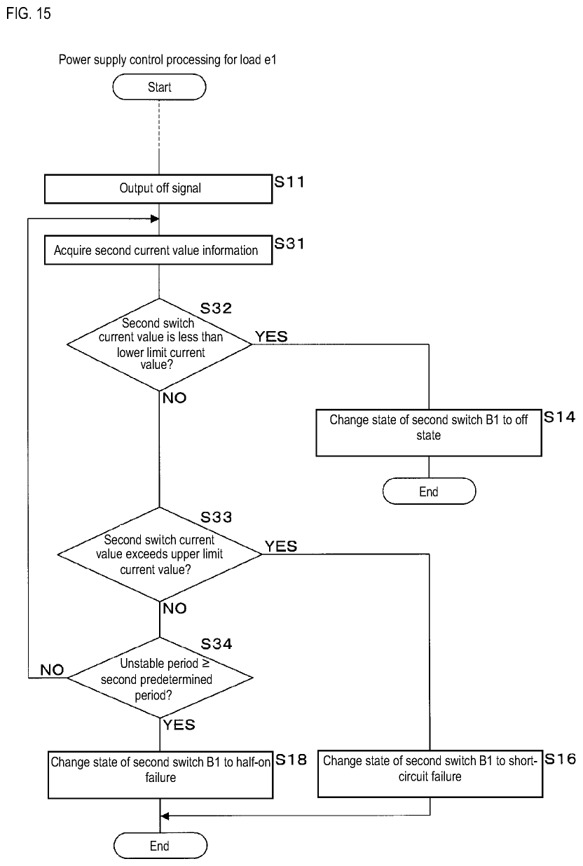

As stated in the description of the first embodiment, the power supply control processing for each of the loads E1, E2, . . . , and En is executed by the control unit 32 when the state of the first switch 20 is the on state. FIG. 15 is a flowchart showing the procedure of power supply control processing for the load E1. In the second embodiment, some steps executed in the power supply control processing for the load E1 are executed in the same manner as in the first embodiment. Description of steps S1 to S11, S14, S16, and S18, which are executed in the same manner as in the first embodiment, is omitted.

As stated in the description of the first embodiment, in the power supply control processing for the load E1, the control unit 32 instructs the second drive circuit F1 to switch the second switch B1 to the off state by executing step S11. After executing step S11, the control unit 32 acquires the second current value information from the A/D conversion unit J1 (step S31). Next, the control unit 32 determines whether or not the second switch current value indicated by the second current value information acquired in step S31 is less than the lower limit current value (step S32).

If the control unit 32 determines that the second switch current value is less than the lower limit current value (S32: YES), the control unit 32 executes step S14. After executing step S14, the control unit 32 ends the power supply control processing for the load E1. In this case, when the first switch 20 is in the on state, the control unit 32 executes the power supply control processing for the load E1 again.

If the control unit 32 determines that the second switch current value is greater than or equal to the lower limit current value (S32: NO), the control unit 32 determines whether or not the second switch current value indicated by the second current value information acquired in step S31 exceeds the upper limit current value (step S33). If the control unit 32 determines that the second switch current value exceeds the upper limit current value (S33: YES), the control unit 32 executes step S16. If the control unit 32 determines that the second switch current value is less than or equal to the upper limit current value (S33: NO), the control unit 32 determines whether or not the unstable period of the second switch B1 is greater than or equal to a second predetermined period determined in advance (step S34).

As described above, the unstable period of the second switch B1 is a period in which the second switch current value of the second switch B1 is a value within the current value range. As stated in the description of the first embodiment, the unstable period is measured by, for example, a timer. The starting point of the unstable period is, for example, the time when step S11 is executed. As stated in the description of FIG. 14, if the unstable period of the second switch B1 is greater than or equal to the second predetermined period, a half-on failure has occurred in the second switch B1.

If the control unit 32 determines that the unstable period is less than the second predetermined period (S34: NO), the control unit 32 executes step S31 again. The control unit 32 determines again whether or not the second switch current value of the second switch B1 indicated by the newly-acquired current value information is a value within the current value range. If the control unit 32 determines that the unstable period is greater than or equal to the second predetermined period (S34: YES), the control unit 32 executes step S18. If one of steps S16 and S18 has been executed, the power supply control processing for the load E1 is ended. In this case, the control unit 32 does not execute the power supply control processing for the load E1 again.

### Power Supply Control Processing for Loads E2, E3, . . . , En

The power supply control processing for each of the loads E2, E3, . . . , and En is executed by the control unit 32 in a manner similar to the power supply control processing for the load E1. The load E1, the second switch B1, the second drive circuit F1, and the second output unit H1, which are described in the description of the power supply control processing for the load E1, respectively correspond to the load Ek, the second switch Bk, the second drive circuit Fk, and the second output unit Hk in the description of the power supply control processing for the load Ek. As stated in the description of the first embodiment, k is any integer greater than or equal to 2 and less than or equal to n.

As described above, in the power supply control processing for the load Ei, if the control unit 32 instructs the second drive circuit Fi to switch the second switch Bi to the off state, the state of the second switch Bi is changed to a half-on failure in the state table T1 when the unstable period of the second switch Bi reaches a value greater than or equal to the second predetermined period. In the switching processing for the first switch 20, the control unit 32 instructs the first drive circuit 23 to switch off the first switch if the state of at least one of the n second switches B1, B2, . . . , and Bn has been changed to a half-on failure in the state table T1. As a result, the state of the first switch 20 switches to the off state, and the flow of current through the second switches B1, B2, . . . , and Bn stops.

Also, in the power supply control processing for the load Ei, if the control unit 32 instructs the second drive circuit Fi to switch the second switch Bi to the off state, the control unit 32 changes the state of the second switch Bi to a short-circuit failure in the state table T1 when the second switch current value of the second switch Bi exceeds the upper limit current value. In the switching processing for the first switch 20, the control unit 32 instructs the first drive circuit 23 to switch off the first switch if the state of the specific switch has been changed to a short-circuit failure in the state table T1. The upper limit current value corresponds to a predetermined current value.

If the state of a second switch that is not the specific switch has been changed to a short-circuit failure in the state table T1, the control unit 32 lowers the average value of the current flowing per unit time through second switches that are in the current conduction state and are not the specific switch. If a short-circuit failure has occurred in a second switch that is not the specific switch, power supply via the second switch in which the short-circuit failure has occurred is permitted. By reducing the average value of the current, a current with a large value is prevented from continuing to flow through the first switch 20.

### Variations of First and Second Embodiments

In the first and second embodiments, the configuration for detecting the first switch current value is not limited to the configuration using the current output circuit 21 and the first resistor 22. For example, within the power supply control device 11, a shunt resistor may be disposed in the path of the current flowing through the drain and the source of the first switch 20. In this case, the voltage between both ends of the shunt resistor is amplified by, for example, a differential amplifier.

The differential amplifier outputs the amplified voltage to the first drive circuit 23. The voltage value output by the differential amplifier functions as analog current value information. Since the resistance value of the shunt resistor is a constant value, the value of the voltage between both ends of the shunt resistor is proportional to the first switch current value. Also, since the amplification factor of the differential amplifier is a constant value, the voltage value output by the differential amplifier is also proportional to the first switch current value. Accordingly, the voltage value output by the differential amplifier indicates the first switch current value.

The method of reducing the average value of the current flowing per unit time through the second switch Bi is not limited to the method of performing PWM control of the second switch Bi. A variable resistor may also be connected between the source of the second switch Bi and one end of the load E1. By adjusting the resistance value of the variable resistor, the average value of the current flowing per unit time through the second switch Bi may be reduced.

The first switch 20 is not limited to an N-channel FET, and may be a P-channel FET, a bipolar transistor, a relay contact, or the like. Accordingly, the first switch 20 may also be different from a semiconductor switch. If the first switch 20 is a relay contact, the first switch current value is detected using, for example, a shunt resistor and a differential amplifier. Also, the second switch Bi is not limited to an N-channel FET, and may be a P-channel FET, a bipolar transistor, or the like. Furthermore, the second switch Bi may also be included in the power supply control device 11.

The control unit 32 need not adjust the average value of the current flowing per unit time according to the one or more second switches that are in the current conduction state, for all of the n second switches B1, B2, . . . , and Bn. Regarding some of the second switches, the duty ratio when the state has been changed to the current conduction state may be fixed. Also, if a short-circuit failure of the second switch Bi is detected, the control unit 32 may also instruct switching of the first switch 20 to the off state regardless of whether or not the second switch Bi is a specific switch.

In the first embodiment, similarly to the second embodiment, the control unit 32 may detect a short-circuit failure of the second switch Bi based on the second switch current value of the second switch Bi. Also, in the second embodiment, the control unit 32 may detect a short-circuit failure of the second switch Bi based on the value of the voltage between both ends of the second switch Bi, similarly to the first embodiment.

In the second embodiment, the configuration for detecting the second switch current value of the second switch Bi is not limited to the configuration using the second current output circuit Ui and the second resistor Ri. For example, a second shunt resistor may be disposed in the path of the current flowing through the drain and the source of the second switch Bi. In this case, the voltage between both ends of the second shunt resistor is amplified by, for example, a second differential amplifier. The second differential amplifier outputs the amplified voltage to the A/D conversion unit Ji. The voltage value output by the second differential amplifier functions as analog second current value information. Since the resistance value of the second shunt resistor is a constant value, the value of the voltage between both ends of the second shunt resistor is proportional to the second switch current value. Also, since the amplification factor of the second differential amplifier is a constant value, the voltage value output by the second differential amplifier is also proportional to the first switch current value. Accordingly, the voltage value output by the second differential amplifier indicates the first switch current value.

The disclosed first and second embodiments are to be considered illustrative in all respects and not restrictive. The scope of the present disclosure is indicated not by the above-described meaning, but by the claims, and is intended to encompass meanings equivalent to the claims and all changes within the scope.

1. A power supply control device comprising:
a first switch; and
a processing unit configured to execute processing,
wherein the processing unit causes a state of each of a plurality of second switches to which current is input from the first switch to transition from an off state to a current conduction state in which current can flow therethrough, and
the processing unit adjusts an average value of current flowing per unit time for at least one of the second switches, according to one or more second switches that are in the current conduction state, and thereby sets an average value of current flowing per unit time through the first switch to less than a value of current flowing through the first switch when the first switch and all of the second switches are fixed in an on state.

2. (canceled)

3. The power supply control device according to claim 1,
wherein when the state of the second switch is fixed in an on state or PWM control of the second switch is performed, the state of the second switch is caused to transition to the current flow state.

4. The power supply control device according to claim 1, further comprising
a switching circuit configured to switch the state of the first switch to an on state or an off state,
wherein the switching circuit switches the state of the first switch to the off state if the value of the current flowing through the first switch reaches a value greater than or equal to a current threshold value.

5. The power supply control device according to claim 1,
wherein the processing unit instructs switching of the second switch to the off state, and
if a period during which a value of a voltage between both ends of the second switch is maintained at a value within a predetermined range reaches a value greater than or equal to a predetermined period when switching of the second switch to the off state has been instructed, the processing unit instructs switching of the first switch to the off state.

6. The power supply control device according to claim 1,
wherein the processing unit instructs switching of the second switch to the off state, and
if a period during which a value of current flowing through the second switch is maintained at a value within a second predetermined range reaches a value greater than or equal to a second predetermined period when switching of the second switch to the off state has been instructed, the processing unit instructs switching of the first switch to the off state.

7. The power supply control device according to claim 1,
wherein the processing unit instructs switching of the second switch to the off state, and
if a value of a voltage between both ends of the second switch is less than a predetermined voltage value when switching of the second switch to the off state has been instructed, the processing unit instructs switching of the first switch to the off state.

8. The power supply control device according to claim 7,
wherein when switching of the second switch to the off state has been instructed, if a value of a voltage between both ends of a specific switch determined in advance among the plurality of second switches is less than the predetermined voltage value, the processing unit instructs switching of the first switch to the off state.

9. The power supply control device according to claim 8,
wherein when switching of the second switch to the off state has been instructed, if the value of the voltage between both ends of a second switch that is not the specific switch is less than the predetermined voltage value, the processing unit lowers the average value of the current flowing per unit time through a second switch that is not the second switch in which the value of the voltage between both ends is less than the predetermined voltage value.

10. The power supply control device according to claim 1,
wherein the processing unit instructs switching of the second switch to the off state, and
if the value of the current flowing through the second switch exceeds a predetermined current value when switching of the second switch to the off state has been instructed, the processing unit instructs switching of the first switch to the off state.

11. The power supply control device according to claim 10,
wherein when switching of the second switch to the off state has been instructed, if a value of current flowing through a specific switch determined in advance among the plurality of second switches exceeds the predetermined current value, the processing unit instructs switching of the first switch to the off state.

12. The power supply control device according to claim 11,
wherein when switching of the second switch to the off state has been instructed, if the value of the current flowing through a second switch that is not the specific switch exceeds the predetermined voltage value, the processing unit lowers the average value of the current flowing per unit time through a second switch that is not the second switch in which the current with the value exceeding the predetermined current value flows.

13. A power supply control program to be executed by a computer, comprising:
a step of causing a state of each of a plurality of second switches to which current is input from a first switch to transition from an off state to a current conduction state in which current flows therethrough; and
a step of adjusting an average value of current flowing per unit time for at least one of the second switches, according to one or more second switches that are in the current conduction state, and thereby setting an average value of current flowing per unit time through the first switch to less than a value of current flowing through the first switch when the first switch and all of the second switches are fixed in an on state.

14. A computer program for causing a computer to execute:
a step of causing a state of each of a plurality of second switches to which current is input from a first switch to transition from an off state to a current conduction state in which current flows therethrough; and
a step of adjusting an average value of current flowing per unit time for at least one of the second switches, according to one or more second switches that are in the current conduction state, and thereby setting an average value of current flowing per unit time through the first switch to less than a value of current flowing through the first switch when the first switch and all of the second switches are fixed in an on state.
